(19) United States
(12) Patent Application Publication
(10) Pub. No.: US 2025/0050520 A1
(43) Pub. Date: Feb. 13, 2025

(54) SHAVING RAZOR CARTRIDGE

(71) Applicant: The Gillette Company LLC, Boston, MA (US)

(72) Inventor: Donald William Loughlin, Natick (OM)

(21) Appl. No.: 18/366,405

(22) Filed: Aug. 7, 2023

(51) Int. Cl. B26B 21/22; B26B 21/40

(52) U.S. Cl. CPC B26B 21/222; B26B 21/4012

(57) ABSTRACT

A shaving razor cartridge. The shaving razor cartridge includes a housing having a front portion and a rear portion and at least one blade having a respective cutting edge. The at least one blade is retained within the housing and is positioned between the front portion and the rear portion. At least one of the front portion and the rear portion has a plurality of dimples extending into a top surface of the housing to a depth of 10 μm to 100 μm. Each of the dimples has an area measured at the top surface of 0.001 mm² to 0.008 mm².

### FIELD OF THE INVENTION

The present invention relates to shaving razors and more particularly to shaving razor cartridges for shaving razors.

### BACKGROUND OF THE INVENTION

Most razors available to consumers include a head or shaving razor cartridge where the friction of the shaving razor cartridge as it passes over the skin of the user during shaving is managed with a combination of placing a low durometer elastomeric material at the leading edge of the housing, to increase friction and create skin stretch, and placing soap or a lubricating material at the trailing edge of the housing, to decrease friction and create the feeling of glide. However, these technologies for managing the friction of the shaving razor cartridge add the cost of additional components and incorporate the use of plastic-based material, which is not considered sustainable.

Therefore, a shaving razor cartridge, and particularly a housing for a shaving razor cartridge, is needed that controls the friction as the shaving razor cartridge passes over the skin without using additional components and, preferably, without using plastic-based materials.

### SUMMARY OF THE INVENTION

The present invention relates to a shaving razor cartridge and to methods of forming a shaving razor cartridge and of forming housing for a shaving razor cartridge.

In one implementation, the shaving razor cartridge can comprise a housing having a front portion and a rear portion and at least one blade having a respective cutting edge. The at least one blade is retained within the housing and positioned between the front portion and the rear portion. At least one of the front portion and the rear portion of the housing has a plurality of dimples extending into a top surface of the housing to a depth of 10 μm to 100 μm. Each of the dimples has an area measured at the top surface of 0.001 mm² to 0.008 mm².

The plurality of dimples can have a density of 25 to 400 dimples per mm² and cover an area of the housing of 50 mm² to 300 mm².

The plurality of dimples can extend into the top surface of the housing to a depth of 20 μm to 70 μm.

The dimples can each be circular at the top surface.

The dimples can be spaced apart by a distance of 50 μm to 200 μm.

The housing can comprise aluminum or steel.

The housing can comprise anodized aluminum.

The plurality of dimples can be in the front portion of the housing.

The plurality of dimples can be in the rear portion of the housing.

The shaving razor cartridge can have a blade platform. The at least one blade can be mounted to the blade platform and the housing can cover the blade platform.

In another implementation, the method of forming a housing for a shaving razor cartridge can comprise: forming a housing blank from a sheet metal substrate; forming an elongated window in the sheet metal substrate; and removing material from a top surface of the sheet metal substrate to a depth of 10 μm to 100 μm to form a plurality of dimples.

Each dimple of the plurality of dimples can have an area measured at the top surface of 0.001 mm² to 0.008 mm².

The plurality of dimples can have a density of 25 to 400 dimples per mm² and can cover an area of the housing of 50 mm² to 300 mm².

The plurality of dimples can extend into the top surface of the housing to a depth of 20 μm to 70 μm.

The dimples can each be circular at the top surface.

The dimples can be spaced apart by a distance of 50 μm to 200 μm.

The housing can comprise a front portion and a rear portion and the plurality of dimples can be positioned in the front portion of the housing.

The housing can comprise a front portion and a rear portion and the plurality of dimples can be positioned in the rear portion of the housing.

Removing material can comprise laser ablating at least 15% of a total area of at least 100 mm² of the housing.

In another implementation, the method of forming a shaving razor cartridge can comprise: forming a housing blank from a sheet metal substrate; forming an elongated window in the sheet metal substrate; forming a housing by forming one or more curved surfaces on the housing blank; removing material from a surface of the sheet metal substrate to a depth of 10 μm to 100 μm to form a plurality of dimples; mounting one or more blades to a blade platform; and covering the blade platform with the housing.

### BRIEF DESCRIPTION OF THE DRAWINGS

While the specification concludes with claims particularly pointing out and distinctly claiming the subject matter that is regarded as forming the present invention, it is believed that the invention will be better understood from the following description, which is taken in conjunction with the accompanying drawings in which like designations are used to designate substantially identical elements, and in which:

FIG. 1 is a front perspective view of an example shaving razor;

FIG. 2 is an exploded view of the shaving razor of FIG. 1;

FIG. 3A is a front perspective view of a first example housing for use in the shaving razor of FIG. 1 with a first plurality of dimples formed on a front portion;

FIG. 3B is a rear perspective view of the housing of FIG. 3A with the first plurality of dimples formed on a rear portion;

FIG. 3C is a front perspective view of the housing of FIG. 3A with the first plurality of dimples formed on the front portion and the rear portion;

FIG. 3D is an enlarged view of a portion of the housing of FIG. 3B;

FIG. 3E is a cross-sectional view of a portion of the housing of FIG. 3D taken along the line 3E of FIG. 3D;

FIG. 4 is a flowchart illustrating an example method for forming a housing for a shaving razor cartridge; and

FIG. 5 is a flowchart illustrating an example method for forming a shaving razor cartridge.

### DETAILED DESCRIPTION OF THE INVENTION

The examples described herein relate to shaving razor cartridges and methods of forming shaving razor cartridges and of forming housings for shaving razor cartridges. The example shaving razor cartridges herein can include housings that have micro-patterns etched into one or more surfaces of the housing by laser ablation/etching to make the surface(s) hydrophilic or hydrophobic and to increase or decrease the friction between the shaving razor cartridge and the skin of a user during shaving. The example housings of the shaving razor cartridges herein are preferably metal, to reduce the use of plastic-based materials, but could also be plastic, which would still reduce the number of components used in the shaving razor cartridge.

Various patterns could be etched into the front and/or rear portion of the housing of the shaving razor cartridge to increase friction and create skin stretch or to decrease friction and create the feeling of glide, depending on the particular application. It is believed, without being held to theory, that some of the surface textures disclosed facilitate the trapping of water and shaving aid that a consumer may use for shaving on the surface of the shaving razor cartridge, as well as removing some of the higher friction metal material from the shaving surface, thus lowering surface friction and improving glide for a more comfortable shave. In addition, the surface textures may also be easily rinsed clean between shaves (e.g., surface texture does not trap shaving debris). It is believed, without being held to theory, that some of the surface textures disclosed may alternatively facilitate the gripping of the skin during a shaving stroke, thus improving skin stretch for a closer and more comfortable shave.

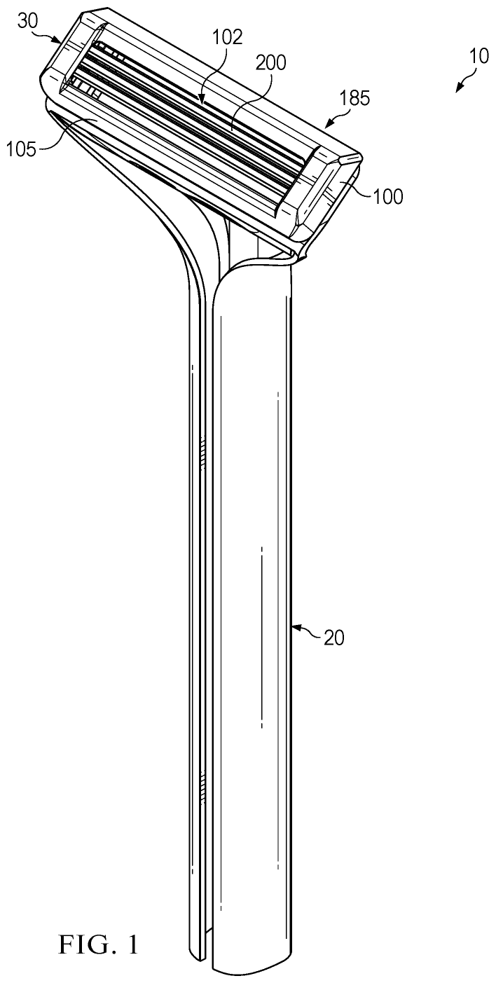

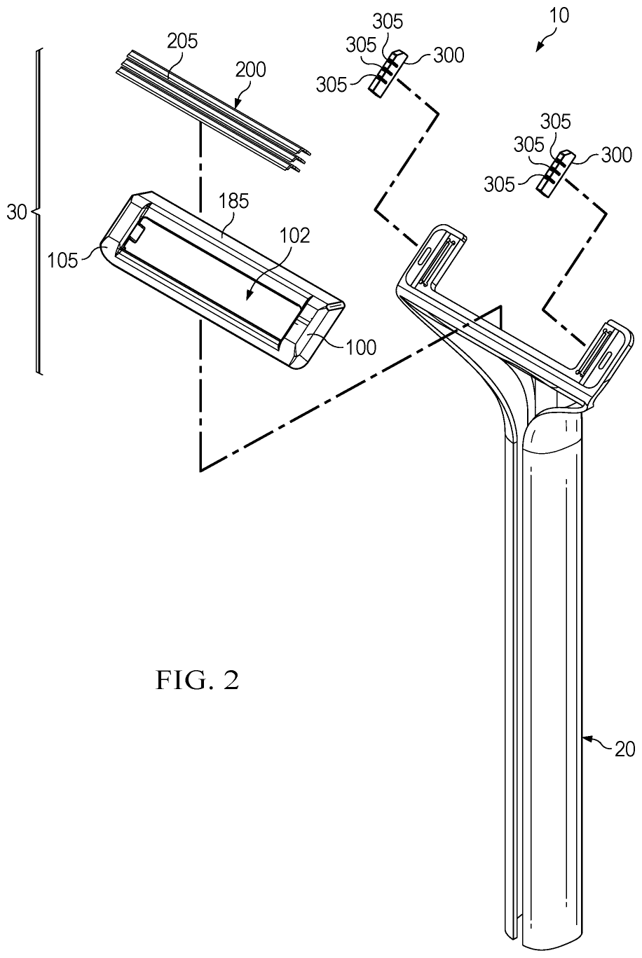

Referring to FIGS. 1-2, an example shaving razor 10 is shown, which generally includes a handle 20 and a shaving razor cartridge 30, which can be connected to, or removably connected to, handle 20. Shaving razor cartridge 30 generally includes a housing 100, which is preferably a metal material, such as aluminum, anodized aluminum, stainless steel, titanium, etc. with a Brinell hardness of 30 to 100, a blade platform 300, and at least one blade 200 having a respective cutting edge 205. A metal housing 100 may facilitate the formation of smaller and more precise features by laser ablation than is typically possible by injection molding plastic materials or machining or laser ablation of plastics. As shown, blades 200 can be mounted to blade platform 300 by positioning blades 200 within slots 305 formed in blade platform 300. Housing 100 can cover blade platform 300 such that blades 200 are retained within housing 100, are positioned between a front portion 105 and a rear portion 185 of housing 100, and are accessible through an elongated window 102 formed in housing 100 between front portion 105 and rear portion 185. As referred to herein, front portion 105 of housing 100 is the portion of housing 100 that engages the skin of a user before blades 200 and rear portion 185 of housing 100 is the portion of housing 100 that engages the skin of the user after blades 200.

Although the particular example shaving razor cartridge 30 is shown and described herein as having housing 100 and a separate blade platform 300, it is understood that the housing and blade platform could be formed together as a single, integral housing that holds the blades and has front and rear surfaces to receive the laser ablation/etching shown and described herein.

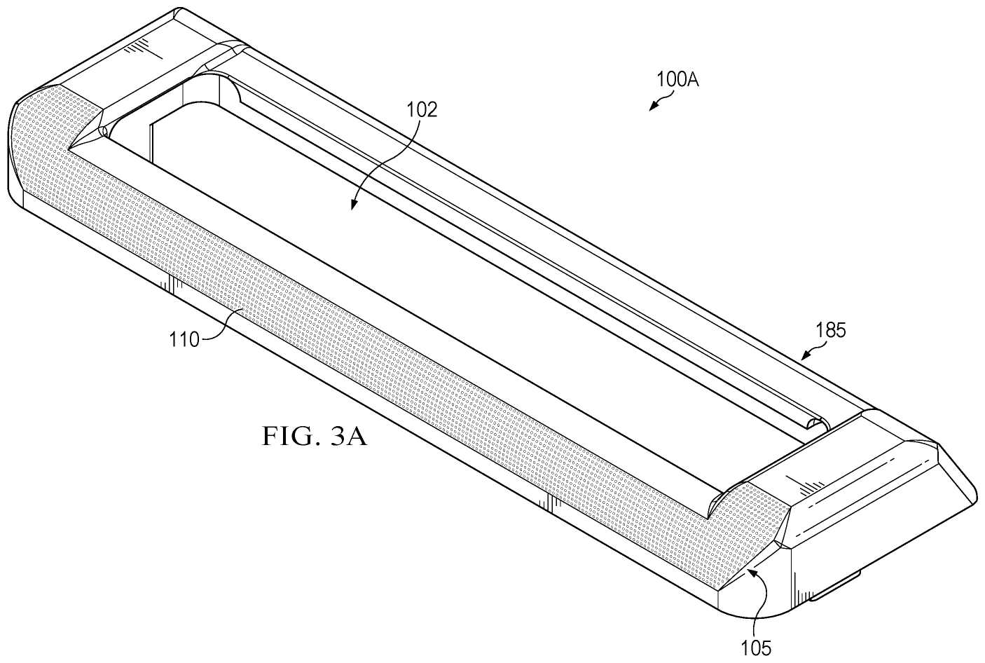

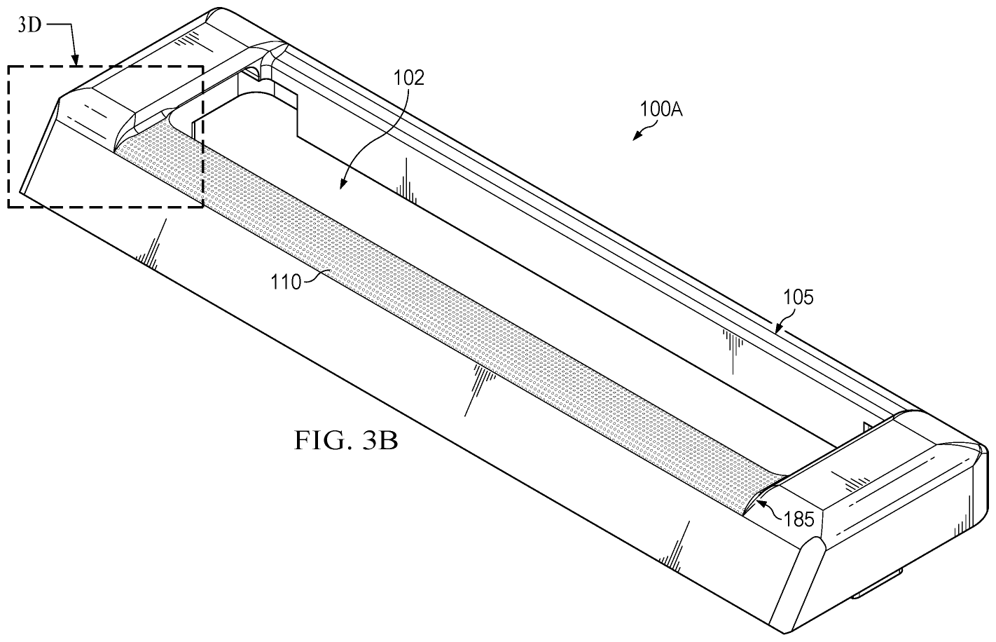

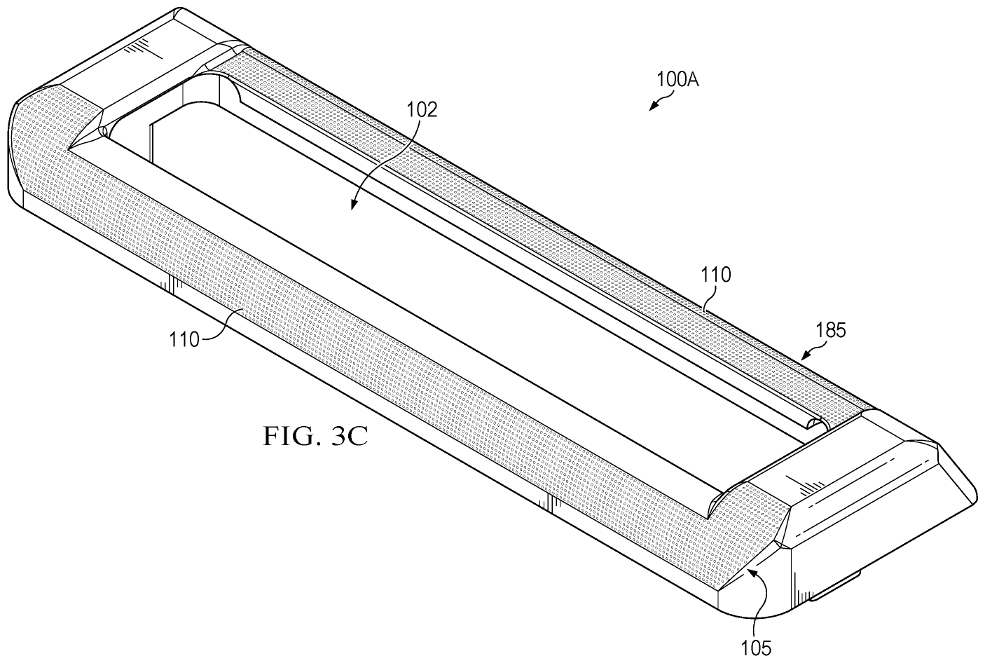

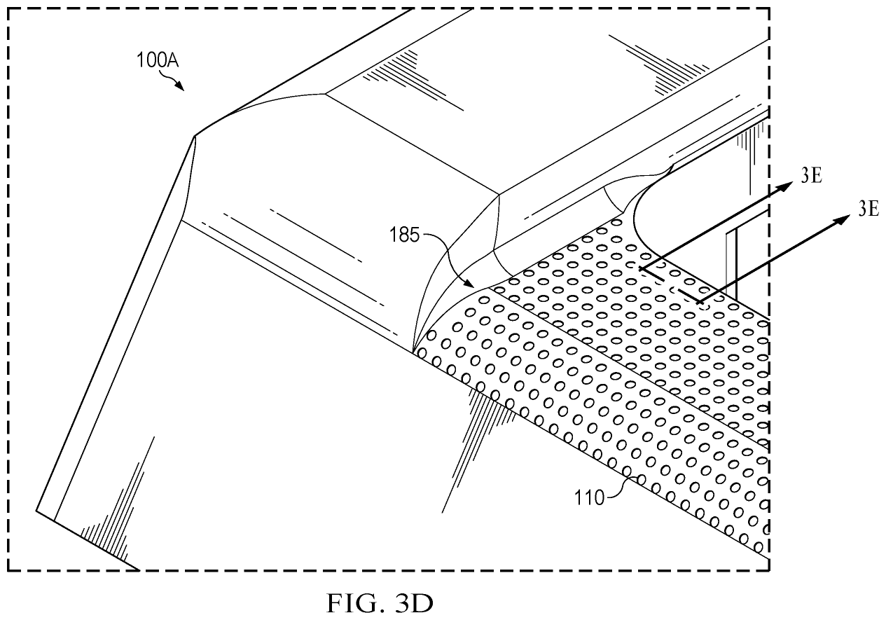

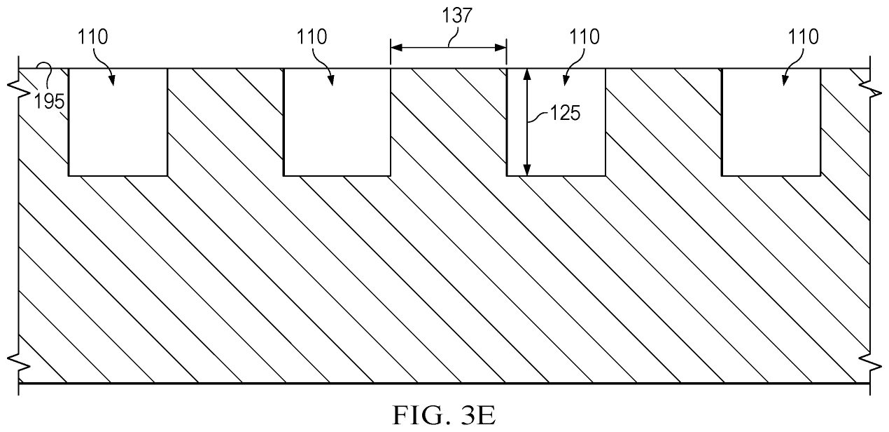

Referring to FIGS. 3A-3E, example housing 100A is illustrated that includes a plurality of dimples 110 that each extend into a top surface 195 of housing 100A to a depth 125 of 10 μm to 100 μm, preferably to a depth 125 of 20 μm to 70 μm, and have an area measured at top surface 195 of 0.001 mm² to 0.008 mm². Dimples 110 can be formed in a front portion 105 of housing 100A (FIG. 3A), a rear portion 185 of housing 100A (FIG. 3B), or front portion 105 and rear portion 185 of housing 100A (FIG. 3C), for example, by laser ablation. In one example, the laser ablation could be performed by an ultrashort pulse laser set at a power setting of 8 μJ and a wavelength of 1030 nm. The beam diameter used could be approximately 50% of the depth of the grooves being formed. Each dimple 110 can be circular at top surface 195, or any other shape appropriate for a given application, and dimples 110 can be spaced apart by a distance 137 of 50 μm to 200 μm, have a density of 25 to 400 dimples per mm², and cover an area of the housing 100A of 50 mm² to 300 mm².

Testing has shown that an aluminum plate having a plurality of dimples (e.g., dimples 110) laser ablated/etched into the surface provides a generally hydrophilic surface. In addition, an aluminum plate having a plurality of dimples (e.g., dimples 110) laser ablated/etched into the surface has a lower coefficient of friction, on average, than an aluminum plate with no surface texturing with the surface dry, wetted with water, and wetted with a shaving aid solution. Therefore, providing a plurality of dimples (e.g., dimples 110) laser ablated/etched into the front portion and/or rear portion of a housing of a shaving razor cartridge will allow the housing to glide over the skin of a user more smoothly and easily than a housing with no textured surfaces.

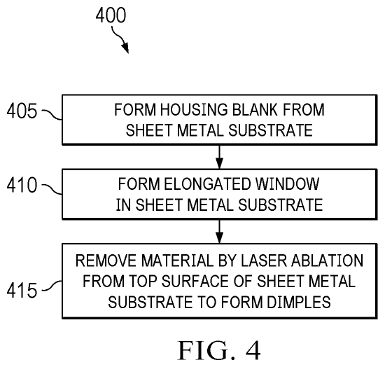

Referring to FIG. 4, an example method 400 for forming a housing (e.g., housing 110A) for a shaving razor cartridge (e.g., shaving razor cartridge 30) is illustrated.

At Step 405 of method 400, a housing blank is formed from a sheet metal substrate. Sheet metal substrate could be any metal material, such as aluminum, anodized aluminum, stainless steel, titanium, etc., and preferably has a Brinell hardness of 30 to 100. The housing blank may be formed using a punch press. However, it is understood other methods may be used, such as, CNC machining, laser machining, press brake equipment or other commonly used metal forming techniques.

At Step 410, an elongated window (e.g., elongated window 102) is formed in the sheet metal substrate.

At Step 415, material is removed by laser ablation from a top surface of the sheet metal substrate adjacent the elongated window to a depth of 10 μm to 100 μm, preferably 20 μm to 70 μm, to form a plurality of dimples (e.g., dimples 110). Each dimple formed can be circular at the top surface, or any other shape appropriate for a given application, and have an area measured at the top surface of 0.001 mm² to 0.008 mm². The dimples can be spaced apart by a distance of 50 μm to 200 μm, have a density of 25 to 400 dimples per mm², and cover an area of the housing of 50 mm² to 300 mm². Preferably, the dimples are formed by laser ablating at least 15% of a total area of at least 100 mm² of the housing.

The area adjacent the elongated window where the dimples are formed could be formed as a front portion of the housing or a rear portion of the housing, so that the dimples are positioned in the front portion of the housing or the rear portion of the housing. In addition, a second plurality of dimples can be formed adjacent the elongated window on an opposite side of the elongated window from the plurality of dimples, so that dimples are positioned on both the front portion and the rear portion of the housing.

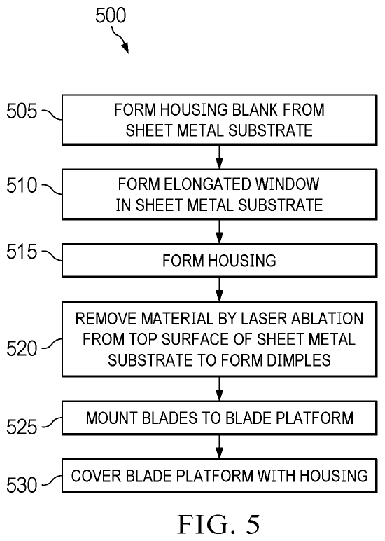

Referring to FIG. 5, an example method 500 for forming a shaving razor cartridge (e.g., shaving razor cartridge 30) is illustrated.

At Step 505 of method 500, a housing blank is formed from a sheet metal substrate. Sheet metal substrate could be any metal material, such as aluminum, anodized aluminum, stainless steel, titanium, etc., and preferably has a Brinell hardness of 30 to 100. The housing blank may be formed using a punch press. However, it is understood other methods may be used, such as, CNC machining, laser machining, press brake equipment or other commonly used metal forming techniques.

At Step 510, an elongated window (e.g., elongated window 102) is formed in the sheet metal substrate.

At Step 515, a housing (e.g., housing 100) is formed by forming one or more curved surfaces on the housing blank.

At Step 520, material is removed by laser ablation from a top surface of the sheet metal substrate adjacent the elongated window to a depth of 10 μm to 100 μm, preferably 40 μm to 60 μm, to form a plurality of dimples (e.g., dimples 110). Each dimple formed can be circular at the top surface, or any other shape appropriate for a given application, and have an area measured at the top surface of 0.001 mm² to 0.008 mm². The dimples can be spaced apart by a distance of 50 μm to 200 μm, have a density of 25 to 400 dimples per mm², and cover an area of the housing of 50 mm² to 300 mm². In certain embodiments, the dimples can be spaced apart by a distance of 75 μm to 125 μm, have a density of 75 to 400 dimples per mm², and cover an area of the housing of 100 mm² to 200 mm². Preferably, the dimples are formed by laser ablating about 15% to about 30% of a total surface area of 100 mm² to 200 mm².

At Step 525, one or more blades (e.g., blades 200) are mounted to a blade platform (e.g., blade platform 300).

At Step 530, the blade platform with the one or more blades mounted thereon is covered with the housing.

The dimensions and values disclosed herein are not to be understood as being strictly limited to the exact numerical values recited. Dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

To the extent that any meaning or definition of a term in this document conflicts with any meaning or definition of the same term in another document, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge, comprising:
a housing having a front portion and a rear portion;
at least one blade having a respective cutting edge, the at least one blade retained within the housing and positioned between the front portion and the rear portion; and
at least one of the front portion and the rear portion having a plurality of dimples extending into a top surface of the housing to a depth of 10 μm to 100 μm, wherein each of the dimples has an area measured at the top surface of 0.001 mm² to 0.008 mm².

2. The shaving razor cartridge of claim 1, wherein the plurality of dimples have a density of 25 to 400 dimples per mm² and cover an area of the housing of 50 mm² to 300 mm².

3. The shaving razor cartridge of claim 1, wherein the plurality of dimples extend into the top surface of the housing to a depth of 20 μm to 70 μm.

4. The shaving razor cartridge of claim 1, wherein the plurality of dimples are each circular at the top surface.

5. The shaving razor cartridge of claim 1, wherein the dimples are spaced apart by a distance of 50 μm to 200 μm.

6. The shaving razor cartridge of claim 1, wherein the housing comprises aluminum or steel.

7. The shaving razor cartridge of claim 1, wherein the housing comprises anodized aluminum.

8. The shaving razor cartridge of claim 1, wherein the plurality of dimples are in the front portion of the housing.

9. The shaving razor cartridge of claim 1, wherein the plurality of dimples are in the rear portion of the housing.

10. The shaving razor cartridge of claim 1, comprising a blade platform, wherein the at least one blade is mounted to the blade platform and the housing covers the blade platform.

11. A method of forming a housing for a shaving razor cartridge, comprising:
forming a housing blank from a sheet metal substrate;
forming an elongated window in the sheet metal substrate; and
removing material from a top surface of the sheet metal substrate to a depth of 10 μm to 100 μm to form a plurality of dimples.

12. The method of claim 11, wherein each dimple of the plurality of dimples has an area measured at the top surface of 0.001 mm² to 0.008 mm².

13. The method of claim 11, wherein the plurality of dimples have a density of 25 to 400 dimples per mm² and cover an area of the housing of 50 mm² to 300 mm².

14. The method of claim 11, wherein the plurality of dimples extend into the top surface of the housing to a depth of 20 μm to 70 μm.

15. The method of claim 11, wherein the plurality of dimples are each circular at the top surface.

16. The method of claim 11, wherein the dimples are spaced apart by a distance of 50 μm to 200 μm.

17. The method of claim 11, wherein the housing comprises a front portion and a rear portion and the plurality of dimples are positioned in the front portion of the housing.

18. The method of claim 11, wherein the housing comprises a front portion and a rear portion and the plurality of dimples are positioned in the rear portion of the housing.

19. The method of claim 11, wherein said removing material comprises laser ablating at least 15% of a total area of at least 100 mm² of the housing.

20. A method of forming a shaving razor cartridge, comprising:
forming a housing blank from a sheet metal substrate;
forming an elongated window in the sheet metal substrate;
forming a housing by forming one or more curved surfaces on the housing blank;
removing material from a surface of the sheet metal substrate to a depth of 10 μm to 100 μm to form a plurality of dimples;
mounting one or more blades to a blade platform; and
covering the blade platform with the housing.
